(19) United States
(12) Patent Application Publication
(10) Pub. No.: US 2020/0216025 A1
(43) Pub. Date: Jul. 9, 2020

(54) SYSTEMS AND METHODS FOR PROVIDING ACCESS TO A VEHICLE USING A WIRELESS ACCESS DEVICE

(71) Applicant: Byton North America Corporation, Santa Clara, CA (US)

(72) Inventors: Benoit Le Bourgeois, San Jose, CA (US); Rene Limberger, Gilroy, CA (US); Yan Deng, San Jose, CA (US); Fei Xiao, San Jose, CA (US)

(21) Appl. No.: 16/240,461

(22) Filed: Jan. 4, 2019

(51) Int. Cl. B60R 25/24; G07C 9/00; G01S 1/20

(52) U.S. Cl. CPC B60R 25/241; G07C 2009/00357; G01S 1/20; G07C 9/00309

(57) ABSTRACT

Disclosed is a method and apparatus for providing access to a system using a wireless access device. The method can include activating a plurality of beacon transceivers of the vehicle. The method may also include determining, based at least in part on at least one beacon message received by the beacon transceivers, the wireless access device, or a combination thereof, when a position of the wireless access device relative to the vehicle satisfies an access threshold. The method may also include, in response to determining that the access threshold has been satisfied, configuring one or more systems of the vehicle based on the position of the wireless access device relative to the vehicle.

### FIELD

The disclosed embodiments relate generally to vehicle systems and in particular, but not exclusively, to enabling systems and devices for providing access to a vehicle using a wireless access device.

### BACKGROUND

Vehicles, such as cars, trucks, trains, etc., generally include a lock to prevent unauthorized access to the vehicle, as well as to prevent the unauthorized starting and operation of the vehicle. While such locks used to involve physical keys, more and more vehicles are using wireless entry and vehicle operation systems. With wireless entry and vehicle operation systems, a hardware device, such as a key fob, provides authentication data to the vehicle. When verified by the vehicle, the user is electronically granted access to the vehicle and/or the ability to start and operate the vehicle. Typically, the key fob and the vehicle continue to exchange wireless authentication data, or other signaling, so that they vehicle can ensure that the key fob, and thus the operator, are still in proximity to the vehicle during operation.

### BRIEF DESCRIPTION OF THE DRAWINGS

FIG. 1 is a block diagram of an exemplary system architecture for enabling position based access to, and configurations of, a vehicle using a wireless access device;

FIG. 2 is block diagram of one embodiment of a system including a vehicle and a wireless access device in communication with one another;

FIG. 3 is a flow diagram of one embodiment of a method for configuring one or more vehicle systems based on authentication and position of a wireless access device using beacon transceivers of a vehicle;

FIG. 4 is a flow diagram of another embodiment of a method for configuring one or more vehicle systems based on authentication and position of a wireless access device using beacon transceivers of a vehicle;

FIG. 5A is a flow diagram of one embodiment of a method for generating radio frequency fingerprints of an environment of a vehicle;

FIG. 5B is a block diagram illustrating the selective transmission of signals from subsets of beacon transceivers during radio frequency fingerprint generation;

FIG. 5B is a block diagram illustrating another selective transmission of signals from a subset of beacon transceivers during radio frequency fingerprint generation;

FIG. 5C is a block diagram illustrating another selective transmission of signals from subsets of beacon transceivers including a central transceiver during radio frequency fingerprint generation;

FIG. 5D is a block diagram illustrating another selective transmission of signals from subsets of beacon transceivers including a central transceiver during radio frequency fingerprint generation;

FIG. 5E is a block diagram illustrating different vehicle environments in which radio frequency fingerprint generation can be performed;

FIG. 6A is a flow diagram of one embodiment of a method for training a machine learning model for use in positioning determination for a wireless access device seeking to access and configure a vehicle; and

FIG. 6B is a block diagram illustrating using a robot to provide different positions of a wireless access device during transmission of a radio frequency signal for reception by vehicle beacon transceivers during machine learning model training;

FIG. 7A is a flow diagram of one embodiment of a method for determining a position of a wireless access device using a subset of beacon transceivers of a vehicle and relative signal strengths of radio signals received by the subset; and

FIG. 7B is a block diagram illustrating a vehicle and a plurality of regions of the vehicle in which a wireless access device can be detected using relative signal strengths of signals generated by the wireless access device and received by subsets of beacon transceivers.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

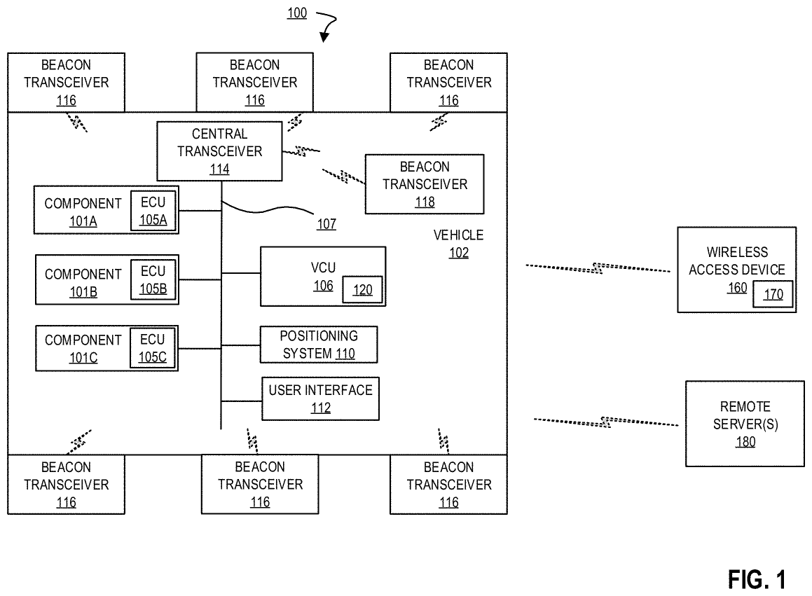

FIG. 1 is a block diagram of an exemplary system architecture 100 for enabling position based access to, and configurations of, a vehicle using a wireless access device. System 100 implements a position based method for granting wireless access device 160 access to vehicle 102 based on reception of beacon messages generated by wireless access device 150, and received by a plurality of beacon transceivers 116 and 118 of the vehicle 102. Furthermore, one or more systems of the vehicle, such as doors, a trunk, windows, etc. may be configured based on one or more configurations associated a determined position of the wireless access device 160 relative to the vehicle 102. Additionally, in embodiments, the position determination of wireless access device 160 performed by the vehicle 102 may be tuned, such that accuracy of the position determination is improved, by distinguishing among different radio frequency (RF) environments in which vehicle 102 is currently located, using a machine learning model based positioning determination, or a combination thereof. These, and other embodiments, will be discussed in greater detail herein.

In embodiments, vehicle 102 may be a fully electric vehicle, partially electric (i.e., hybrid) vehicles, non-electric vehicles (i.e., vehicle with a traditional internal combustion engine). Furthermore, although described mostly in the context of automobiles, the illustrated systems and methods can also be used in other wheeled vehicles such as trucks, motorcycles, buses, trains, etc. It can also be used in non-wheeled vehicles such as ships, airplanes (powered or gliders), and rockets. In fact, the illustrated embodiments can be used in any situation in which it is useful to provide wireless access using a wireless access device. Additionally, embodiments discussed herein may also be used to control access to other systems (e.g., unlock and/or open residential or commercial doors), configure lighting systems (e.g., turn on exterior and/or interior lights), or any other system that can utilize secure authenticated micro localization to control its operation.

In embodiments, wireless access device 160 is a hardware device capable of wirelessly transmitting and receiving data, and performing authentication and beacon message transmission processes, as discussed in greater detail herein. Wireless access device 160 may be a purpose built device, such as a key fob, that's primary function is as a wireless key for providing access to, and enabling configuration of operation of, vehicle 102. In embodiments, however, wireless access device 160 may be any wireless device with a transceiver, memory, and processor configured to perform the processes discussed herein. For example, a smartphone, smart watch, wearable device, tablet computer, or other wireless device may be configured to perform the functions of wireless access device 160, such as by execution of application 170 associated with a manufacturer of vehicle 102. In other embodiments, wireless access device 160 can be a purpose built device, such as a credit card sized, key chain sized, etc. device having communication capabilities (e.g., Bluetooth, Bluetooth Low Energy, wireless local area network (WLAN), etc. communication capabilities), processing capabilities (e.g., a microprocessor), a power source (e.g., a coin cell battery or other battery capable of powering the purpose built device, and in some embodiments providing long battery life, such as 2 or more years), one or more user interface elements for activating the device (e.g., a button, a switch, etc. that can be used by a user to turn on the card for performing processes discussed herein), and memory resources (e.g., a local storage), and being capable of performing the techniques discussed herein independently, or when paired with another device (e.g., a smartphone). Furthermore, each of these wireless access devices for accessing vehicle may be used in conjunction with one another (e.g., so that notifications, such as low battery of an access device communicated in a beacon message or other wireless message, may generate notifications to other device(s), prompt battery charging or replacement, prompt a user to select among available entry device(s) etc.), or separately, for example as a backup (e.g., a key fob or mobile device's battery has died), for providing to a valet (e.g., providing limited access and use to vehicle), etc. However, to avoid obscuring embodiments of the present invention, the remainder of the present disclosure will refer to a wireless access device 160.

In embodiments, wireless access device 160 may be water resistant to provide continuous use in inclement weather, when dropped in a puddle, etc., and may also include a physical key for providing access to vehicle 102 via a corresponding key cylinder of the vehicle 102, for example during an emergency, in response to a dead battery of key fob, by a user uncomfortable with wireless entry systems, etc.

In one embodiment, vehicle 102 includes one or more systems, such as components 101, each having an electronic control unit (ECU) 105, and each ECU 105 is communicatively coupled via a communications network 107 to a vehicle control unit (VCU) 106. The communications network 107 may be a controller area network (CAN), an Ethernet network, a wireless communications network, another type of communications network, or a combination of different communication networks. VCU 106 is also communicatively coupled to a positioning system 110 (e.g., a satellite navigation system), a user interface 112, a central transceiver 114, and a plurality of beacon transceivers (e.g., beacon transceivers 116 and 118). Central transceiver 114 is communicatively coupled to antennas (not shown), through which vehicle 102 can wirelessly transmit data to, and receive data from, wireless access device 160, as well as other systems (e.g., LAN access points, WAN access points, other vehicles, security servers, remote maintenance systems, etc.). In embodiments, beacon transceivers 116 and 118 are communicably coupled with central transceiver 114 via a wireless communication link for transmitting and receiving wireless messages in a personal area network, such as a Bluetooth™, Bluetooth™ low energy (BLE), Zigbee, or other wireless personal area network, consistent with the discussion herein. In another embodiment, beacon transceivers 116 and 118 are communicably coupled with central transceiver 114 via a wired communications link for transmitting and receiving messages, as discussed herein. In either embodiment, beacon transceivers 116 are distributed around an exterior of vehicle 102, such as outside the metal body or frame of vehicle 102, to prevent distortion of signals received by beacon transceivers 116 and transmitted by wireless access device 160 when wireless access device 160 is outside vehicle. However, beacon transceivers 116 may be placed behind or within a non-interfering material, such as within vehicle bumpers, behind non-metallic paneling, etc. to hide and protect the beacon transceivers from damage due to debris, weather, etc. during vehicle operation. In embodiment, there may be a plurality of exterior beacon transceivers 116 distributed at different positions of the vehicle, such as two in a rear of the vehicle (e.g., rear bumper), one on each side of the vehicle (e.g., in door paneling), and two in a front of the vehicle 102 (e.g., front bumper). In embodiments, any number of beacon transceivers 116 may be utilized and may be distributed around the exterior perimeter of the vehicle 102. In embodiments, vehicle 102 includes at least one interior beacon transceiver 118 located in an interior of the vehicle, such as within the metal body, passenger cabin, etc. of the vehicle. Similar to the discussion above, beacon transceiver 118 may be may be placed behind or within a non-interfering material, such as behind interior paneling, to hide and protect the interior beacon transceiver(s) from view of vehicle occupants. In embodiments, as described and illustrated herein, the arrangement of beacon transceivers 116 and 118 within and outside of vehicle 102 enables improved position determination of wireless access device 160, and therefore improved access and configuration of vehicle 102 itself.

Components 101 are generally systems of the vehicle 102. For example, components 101 can include adjustable seat actuators, power inverters, window electronic control unit, electronic control unit for braking systems, etc. Vehicle control unit (VCU) 106 is a controller including a microprocessor, memory, storage, and a communication interface with which it can communicate with components 101, positioning system 110, user interface 112, central transceiver 114, and transceivers 116 and 118 via network 107. In embodiments, central transceiver 114 and beacon transceivers 116 and 118 may also communicate wirelessly with one another and/or VCU 106 using, for example, a local or personal area wireless network connection. In one embodiment VCU 106 is the vehicle's main computer, but in other embodiments it can be a component separate from the vehicle's main or primary computer.

In one embodiment, VCU 106 includes a vehicle access manager 120 that is used for vehicle-side management of providing keyless access using wireless access device 160 to vehicle 102 based at least in part on determined position of wireless access device 160 relative to vehicle 102 and/or keyless access or configuration of vehicle systems (e.g., unlocking doors, opening a trunk, rolling down windows, starting a vehicle ignition, authorizing vehicle operation, etc.) based at least in part on the determined position of wireless access device 160, as discussed in greater detail below. Similarly, wireless access device 160 also includes a device access manager 170 for device-side management and controlling messaging of wireless access device 160 with vehicle 102, as discussed in greater detail below. The vehicle and device managers 120 and 170 may be software executed by respective processors of vehicle 102 and wireless access device 160, may be hardware (circuitry, dedicated logic, etc.), firmware, or a combination. Furthermore, the vehicle and device managers 120 and 170 may each be configured to execute secure encryption protocols, such as advanced encryption standard (AES) encryption protocols including AES128 encryption, authenticated encryption protocols, such as CCM mode of AES, GCM mode of AES, etc., as well as other encryption protocols during the exchange of wireless messages to ensure the privacy of the content within the messages. The usage of such encryption protocols and techniques in authenticating wireless access device 160 to vehicle 102 ensures that the encryption techniques used are trusted, known to be secure, and provide the ability to safeguard the data that has been encrypted and exchanged wirelessly between the vehicle 102 and wireless access device 160. Other encryption protocols may be used by vehicle and device access managers 120 and 170 in accordance with the discussion herein, for example, using message authentication code (MAC) tags for encrypted messages to provide message and content authentication, adding nonce data to encrypted messages (e.g., arbitrary random numbers prepended to an encrypted message payload and used only once during cryptographic message exchange to ensure message freshness, to prevent replay attacks, and to serve as an initialization vector or nonce for the encryption process itself), etc.

In embodiments, wireless access device 160 initially communicates a wireless message to vehicle 102. In embodiments, it is assumed that wireless access device 160 has previously completed an enrollment process that, for example, has authenticated (e.g., paired and/or bonded) wireless access device 160 to vehicle 102, has provided one or more identifiers of wireless access device 160 and/or user(s) of wireless access device 160, as well as other data that is used by vehicle to authenticate and identify wireless access device 160 as an authorized device for access vehicle 102. In embodiments, the wireless message transmitted from wireless access device 160 is transmitted by device access manager 170 in response to a user pressing a button, selecting an application user interface element, initiating a motion gesture command, etc.

Central transceiver 114 receives the wireless message. Initially, central transceiver 114 and wireless access device 160 may perform an authentication process to, for example, exchange identifiers, establish session keys, negotiate encryption keys, establish wireless communication protocol parameters, and otherwise authenticate wireless access device 160 to vehicle 102 as an authorized device for accessing and/or operating vehicle 102. In embodiments, central transceiver 114 is the main transceiver that controls the remaining vehicle transceivers (e.g. 116 and 118). Furthermore, those transceivers (e.g. 116 and 118) may remain in an inactive state until woken by central transceiver 114. Therefore, in response to receiving the wireless message from wireless access device 160 and successfully authenticating wireless access device 160, central transceiver 114 activates transceivers 116 and 118, such as by causing the transceiver to transition to an active mode in which they are configured to send and/or receive beacon messages to/from wireless access device 160.

In embodiments, and as discussed in greater detail herein, after successfully authenticating wireless access device 160, vehicle access manager 120 may optionally detect a radio frequency (RF) environment in which vehicle 102 is currently located. In embodiments, the RF environment may include the physical surroundings of the environment, such as other cars, walls, enclosures, etc. that may impact the transmission and/or reception of wireless signals. Based on the RF environment detection, vehicle access manager 120 may select, tune, or input the RF environment to a machine learning model based positioning process for detecting a position of wireless access device 160. That is, for example, beacon message reception and transmission may be impacted when there is another vehicle between wireless access device 160 and vehicle 102. In embodiments, the RF environment detection assists vehicle 102 in detecting the environment, and then using that detection to tune a position determination process.

In embodiments, and further in response to successfully authenticating wireless access device 160, vehicle access manager 120 then transmits via central transceiver 114, a request for wireless access device 160 to transmit one or more beacon messages. The beacon messages may be transmitted wirelessly by wireless access device 160 periodically. Furthermore, the beacon messages may include a header that identifies the message, and a payload carrying data, such as wireless access device and/or user identifiers, battery data, command data, signal transmit power, any known position data, etc. Furthermore, as discussed herein, the beacon message may encrypt sensitive information prior to transmission based on a negotiated encryption protocol and/or keys.

In embodiments, the activated beacon transceivers 116 and 118 receive the beacon message(s) transmitted by wireless access device 160, and measure signal data, such as signal strength, of the received messages. Beacon transceivers 116 and 118 then forward the received beacon messages and any additional data (e.g., measured signal strength upon reception) by wired or wireless in-vehicle connection (e.g. a local or personal area network) to central transceiver 114. Central transceiver 114 in turn provides the beacon messages and other data to vehicle access manager 120 of VCU 106. In another embodiment, beacon transceivers 116 and 118 may provide the received beacon messages and additional data directly to vehicle access manager 106 without first forwarding the messages to central transceiver 114.

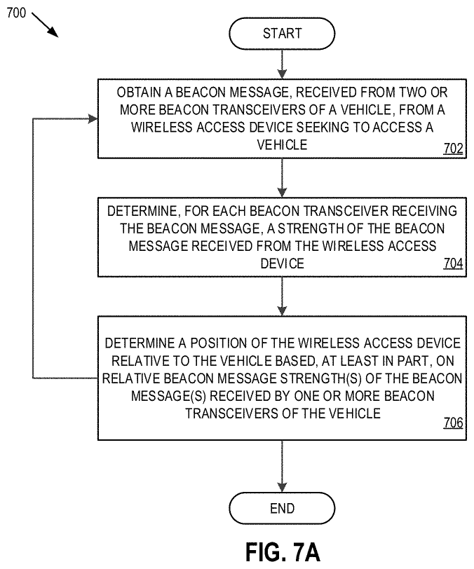

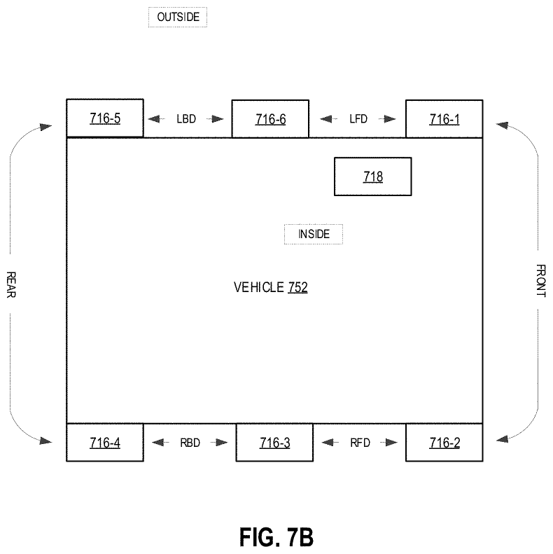

In either embodiment, vehicle access manager 120 extracts signal data, such as transmit signal strength, identifiers, relative signal strengths of the received signals, etc. from the messages received by each of beacon transceivers 116 and 118. Then, based on the extracted data and additional data generated by the transceivers 116 and 118, vehicle access manager 120 performs a positioning process to determine a position of wireless access device 160 relative to the vehicle 102. The position may be a real world position, a relative position to vehicle, a range/distance from a relative position of vehicle, etc. In embodiments, the pattern of reception of the beacon messages (e.g., reception signal strength such as RSSI measurements, transmit signal strength, etc.) by beacon transceivers 116 and 118 enables vehicle access manager 120 to detect wireless access device's position. In embodiments, the position determination can be based on, for example, which pair of beacon transceivers receive the strongest beacon message (e.g., wireless access device 160 is determined to be located between the two beacon transceivers that receive the strongest signal), trilateration based on received/transmit signal strengths, a strength of signal by interior beacon transceiver 118 being stronger than exterior beacon transceivers 116 (e.g., indicating wireless access device 160 is within vehicle 102), pattern recognition by a machine learning model (trained using known transmission positions and received signal data as discussed in greater detail below), other position determination techniques (e.g., tend, sorted table, and/or token based techniques), or a combination of methods. For example, a combination of positioning techniques may be used with one another (e.g., using relative strength of receives signals as a cross-check with a machine learning model based position determination). Additionally, real world machine learning model training data may be generated by vehicle access manager when, for example, a machine learning model based position determination differs from another position determination (e.g., measuring relative signal strengths of received messages as discussed in greater detail below with respect to FIGS. 7A and 7B).

In embodiments, the determined position of wireless access device 160 may then be compared by vehicle access manager 120 to one or more access threshold(s). In embodiments, the one or more access thresholds may be associated with a distance away from vehicle where access should not be granted (e.g., distance >x meters) and where access should be granted (e.g., distance <=x meters), as well a relative position associated with the vehicle, such as left front door, left back door, right front door, right back door, rear, front, inside vehicle, etc. as determined by the wireless access device's 160 detected position. In another embodiment, a real world position relative to the vehicle 102 may be determined by vehicle access manager 120 from the received beacon message data. In yet another embodiment, a position of wireless access device 160 over time may be tracked to detect a trajectory or movement of wireless access device 160 relative to vehicle 102. In this embodiments, vehicle access manager 120 can more accurately determine a position of wireless access device 160 relative to vehicle, determine when wireless access device 160 is approaching or moving away from vehicle, determine when wireless access device 160 move between regions of vehicle (e.g., outside to inside, left front door region to left rear door region, etc.).

In embodiments, each of beacon transceivers 116 and 118 may be configured to transmit a beacon message for reception by wireless access device 160. In embodiments, device access manager 170 can utilize the received message to make a position determination, as discussed above. In other embodiments, device access manger 170 can transmit the received messages, along with any additional data (e.g., measured strength of received signals), to central transceiver 114, which can then be forwarded to device access manager 120 for analysis as discussed above.

In one embodiment, both wireless access device 160 and transceivers 116 and 118 transmit beacon messages. In this embodiment, both the wireless access device 160 and transceivers 116 and 118 can then be used to receive beacon messages for determining a position of wireless access device 160. In this embodiment, the position determination using beacon messages transmitted by transceivers 116 and 118 and received by wireless access device 160, and beacon messages transmitted by wireless access device 160 and received by transceivers 116 and 118, may act as a check against one another to ensure consistency and verify accuracy of the determined position.

In the embodiments discussed herein, any of beacon transceivers 116 and 118, and wireless access device 160, may be configured to be a beacon signal transmitter and/or beacon signal receiver for determining a position of the wireless access device 160 relative to vehicle 102 consistent with the discussion herein. However, to avoid obscuring embodiments of the present disclosure, and to more clearly describe techniques for determining the position of the wireless access device 160, the remaining discussion will focus on the wireless access device 160 being the beacon signal transmitter, and the beacon transceivers 116 and 118 being the receivers of the beacon signals. The embodiments of the present inventions, however, are limited to this embodiment.

In any embodiment, vehicle access manager 120 may utilize a determined identity of a user/device seeking access (e.g., is user/device associate with driving authorization that may be granted to a vehicle owner, is user/device associated with access but no driving authorization such as that which may be granted to a child of the vehicle owner, etc.) along with the detected position of the wireless access device to selectively configure different vehicle systems. That is, a determined position of a wireless access device associated with operational permission may grant access to a driver side front door and may enable the startup and driving systems of the vehicle 102. In contrast, a determined position of a wireless access device associated with access only (and not operational) permission may only grant access to open vehicle doors, permit turning on and operation of entertainment systems, etc. In embodiments, the configuration can include some or all of the following operational permissions: unlocking doors, opening doors, unlocking a trunk, unlocking a charging port cap, opening/closing windows, turning on and operating entertainment systems, as well as many other vehicle configurations that may be initiated by, and associated with, an authenticated user.

In embodiments, determined positions of wireless access device 160 and the signal measurements (e.g., from beacon messages received by beacon transceivers and/or wireless access device) used in making the position determinations, are transmitted to remote server(s) 180. In embodiments, a transceiver of vehicle 102, such as central transceiver 114 or other transceiver, communicably couples vehicle 102 to remote server(s) 180 over, for example a wide area network, a telecommunications network, a local area network, or a combination of networks. In embodiments, remote server(s) 180 can collect the position determination and signal data used in making the position determinations as, for example, training data for refining a machine learning model that is used by a plurality of vehicles (e.g., vehicles of a manufacturer being of the same model and/or model year such that physical properties the vehicles and transceiver placement is the same), adjust thresholds based on multiple user/vehicle experience and feedback, etc. In response to MLM refinement, threshold adjustments, signal strength measurement analysis adjustments, etc., remote server(s) 180 may distribute updates to vehicle 102 as well as other vehicles.

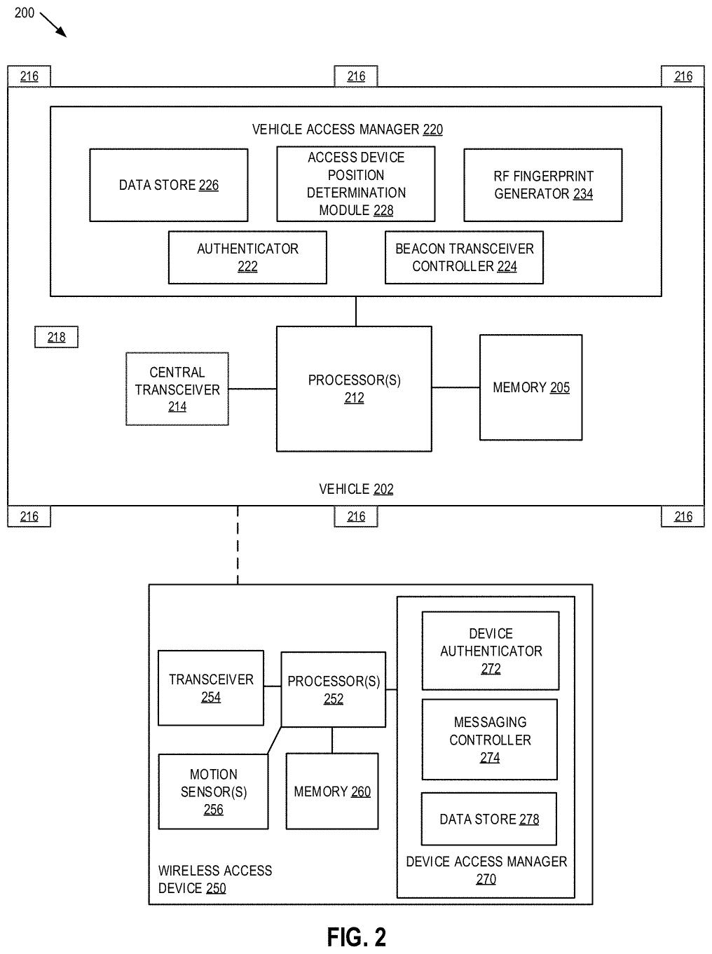

FIG. 2 is block diagram of one embodiment of a system 200 including a vehicle 202 and a wireless access device 250. Vehicle 202 and wireless access device 250 provide additional details for vehicle 102 and a wireless access device 160 discussed above in FIG. 1.

In one embodiment, vehicle 202 is a system, which may include one or more processor(s) 212, a memory 205, a central transceiver 214, a plurality of external transceivers 216, and at least one internal transceiver 218. In embodiments, transceivers 216 and 218 are wired or wireless personal area network transceivers, such as a Bluetooth, BLE, Zigbee, or other personal area network transceivers. It should be appreciated that vehicle 202 may also include, although not illustrated, a user and/or hardware interface, vehicle controls, one or more power device(s) (e.g., vehicle battery, drive control system, one or more vehicle systems (e.g., VCUs, positioning systems, etc.) etc.), a propulsion system (e.g. an electric, gasoline, etc. powered motor), a steering system, a braking system, as well as other components typically associated with vehicles. It is to be understood that vehicle 202 may include a separate network interface (not shown) that may be capable of communicatively coupling vehicle 202 to any number of wireless subsystems (e.g., Bluetooth, WiFi, Cellular, or other networks), internal vehicle communication networks (e.g., a CAN bus, an Ethernet network, a wireless network, etc.) to transmit and receive data streams through one or more communication links.

In one embodiment, wireless access device 250 is also a wireless device, which may include one or more processor(s) 252, a memory 260, one or more motion sensor(s) 256 (e.g., one or more of an accelerometer, gyroscope, inertial measurement unit, etc.), and a transceiver 254. In embodiments, transceiver 254 is also a personal area network transceiver, such as a Bluetooth, BLE, Zigbee, or other personal area network transceiver. It should be appreciated that wireless access device 250 may also include, although not illustrated, a user interface (e.g., keyboard, touch-screen, buttons, or similar devices), a power device (e.g., a battery), a display screen (e.g., an LCD display), as well as other components typically associated with wireless devices. As discussed above, wireless access device 250 may be implemented using a purpose built device (e.g., a key fob, an access card, etc.), or using the hardware and processing resources of a mobile computing system (e.g., a smart phone, a wearable device, etc.), as well as using other wireless devices with sufficient hardware and/or software capabilities for performing the processes discussed herein.

In embodiments, the memories (e.g., memory 205 and memory 260) of vehicle 202 and wireless access device 250 may be coupled to processor(s) to store instructions for execution by the processors, such as processor (s) 212 and processors 252. In some embodiments, the memory is non-transitory, and may store one or more processing modules. In one embodiment, memory 205 of vehicle 202 may store one or more processing modules of a vehicle manager 220, such as an authenticator 222, beacon transceiver controller 224, data store 226, access device position determination module 228, and an optional radio frequency (RF) fingerprint generator 234, to implement embodiments described herein. Furthermore, memory 260 of wireless access device 250 may also include a device access manager 270, including a device authenticator 272, beacon transceiver controller 274, and data store 278.

It should be appreciated that the embodiments as will be hereinafter described may be implemented through the execution of instructions, for example as stored in memory or other element, by processor(s) and/or other circuitry of vehicle 202 and wireless access device 250. Particularly, circuitry of vehicle 202 and wireless access device 250, including but not limited to processor(s) 212 and processor(s) 252 may operate under the control of a program, routine, or the execution of instructions to execute methods or processes in accordance with the aspects and features described herein. For example, such a program may be implemented in firmware or software (e.g. stored in memory 205 and/or memory 260) and may be implemented by processors, such as processor(s) 212 and processor(s) 252, and/or other circuitry. Further, it should be appreciated that the terms processor, microprocessor, circuitry, controller, etc., may refer to any type of logic or circuitry capable of executing logic, commands, instructions, software, firmware, functionality and the like.

In one embodiment, wireless access device 250 includes device authenticator 272 for engaging in an authentication process with authenticator 222 of vehicle 202. For example, the authentication process can include exchanging encryption keys, identifiers, performing attestation, negotiating a connection, etc. for wireless communications between vehicle 202 and wireless access device 250. The authentication process verifies that the wireless access device 250 and/or a user associated with the wireless access device is authorized to access and/or operate the vehicle (e.g., by matching authorized device/user identifiers stored in data store 226), and further enables vehicle access manager 220 to obtain specific configuration settings for unlocking doors, providing operational control, etc. from data store 226. In embodiments, the authentication process is initiated when device authenticator 272 of wireless access device 250 communicates a request to access vehicle 202.

In response to the authentication process being completed, where the wireless access device 250 is verified as an authorized device and/or associated with an authorized user, beacon transceiver controller 224 activates beacon transceivers 216 and 218. To preserve power, beacon transceivers 216 and 218 may enter a low power state when not actively used, and activation includes waking the transceivers. Furthermore, beacon transceiver controller 224 instructs the beacon transceivers to receive beacon message(s) transmitted form the authenticated wireless access device 250. Additionally, beacon transceiver controller 224 further sends a request via central transceiver 214 to the transceiver 254 of wireless access device 250 for wireless access device to begin sending beacon messages. By activating the beacon transceivers 216 and 218, and requesting that wireless access device 250 generate and transmit beacon messages, the wireless access device 250 positioning and vehicle configuration processes are initiated.

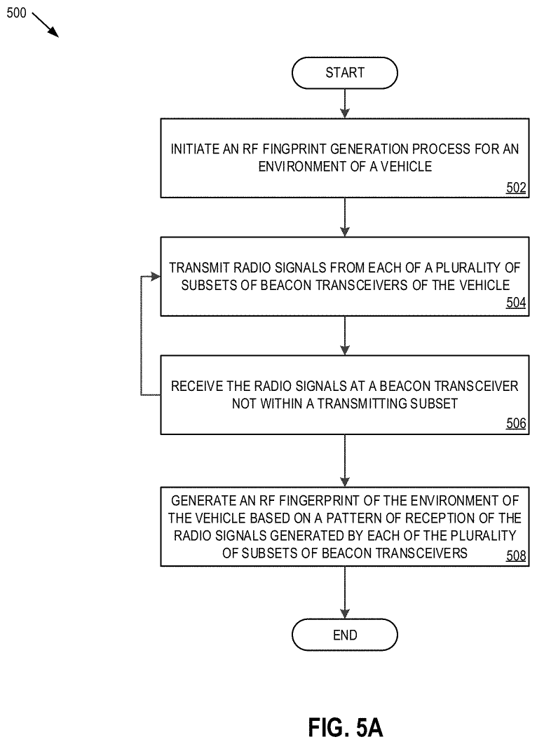

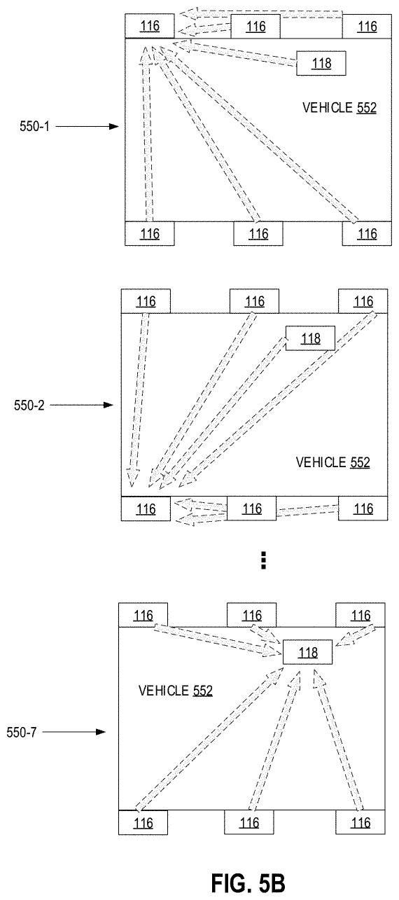

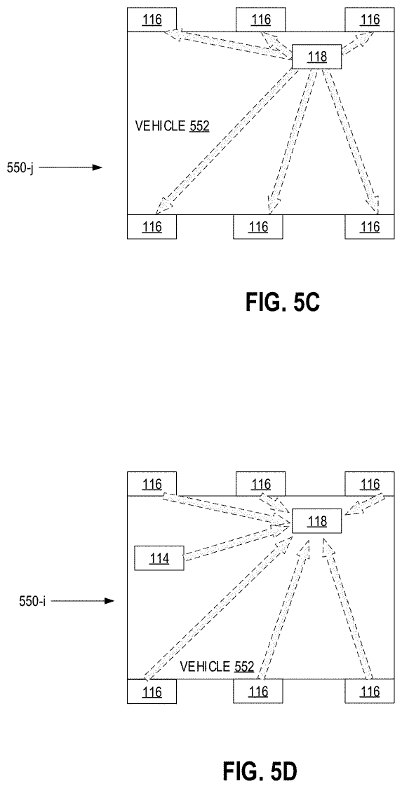

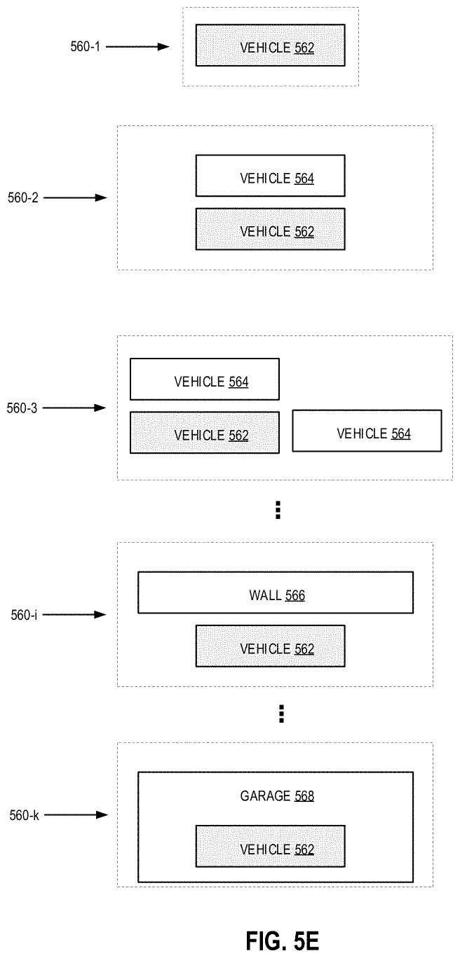

As discussed in greater detail below, RF fingerprint generator 234 may optionally generate an RF fingerprint of the current environment in which vehicle is located. In embodiments, subsets of beacon transceivers, corresponding to tuples of beacon transceivers are selectively activated as transceivers, and the remaining beacon transceivers are selectively activated to receive the signal generated by the transmitting transceivers. For example, the tuples may include any of the following: one transceiver transmitting to 6 receivers (e.g., tuple 1-6) for each vehicle transceiver, two transceivers transmitting to 5 receivers (e.g., tuple 2-5) for each pair of vehicle transceivers, through six transceivers transmitting to 1 receiver (e.g., tuple 1-6) for each collection of six transceivers. In embodiments, central transceiver may also be used as a transmitter/receiver when generating RF fingerprints, enabling tuples 1-7 through 7-1. Additionally, in embodiments, not all tuples need to be used or variations within a tuple, as any combination of transmitters, receivers from the different tuples can be used consistent with the discussion herein. For example, one of transceivers 216 and 218 is selectively activated to transmit a wireless message for receipt by the other transceivers 216 and 218, which is repeated until all transceivers have transmitted at least one wireless message. Then, a profile of the received messages (e.g., relative signal strength of received messages and/or a pattern of signal strengths) for the various tuples used in generating the RF fingerprint, can be compared to pre-generated RF fingerprints (e.g., fingerprints generated for the tuples in a plurality of different environments). Based on the comparison of a generated RF fingerprint with pre-generated RF fingerprints, a likely RF environment in which the vehicle is located may be determined. In embodiments, the likely RF environment may be used to tune the machine learning module used during wireless access device position determination (e.g., by modifying variables, weighting, etc. in a machine learning model, such as a neural network, trained for determining device position as discussed below). RF fingerprint generation is discussed in greater detail below with reference to FIGS. 5A-5E.

In response to the request, messaging controller 274 of device access manager 270 generates one or more beacon messages that are transmitted by transceiver 254. In one embodiment, the beacon messages include various data, such as device and/or user identifiers, transmit signal strength, positioning data (e.g., GPS data), as well as other data.

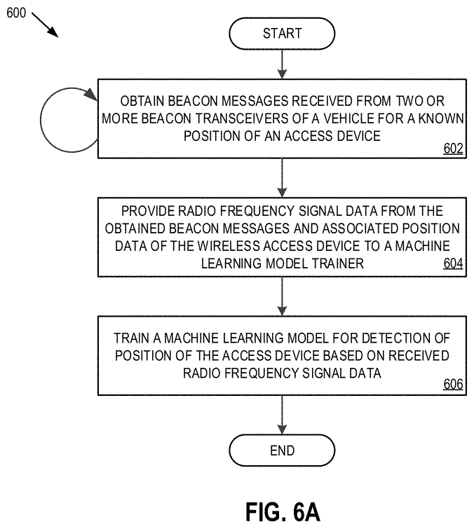

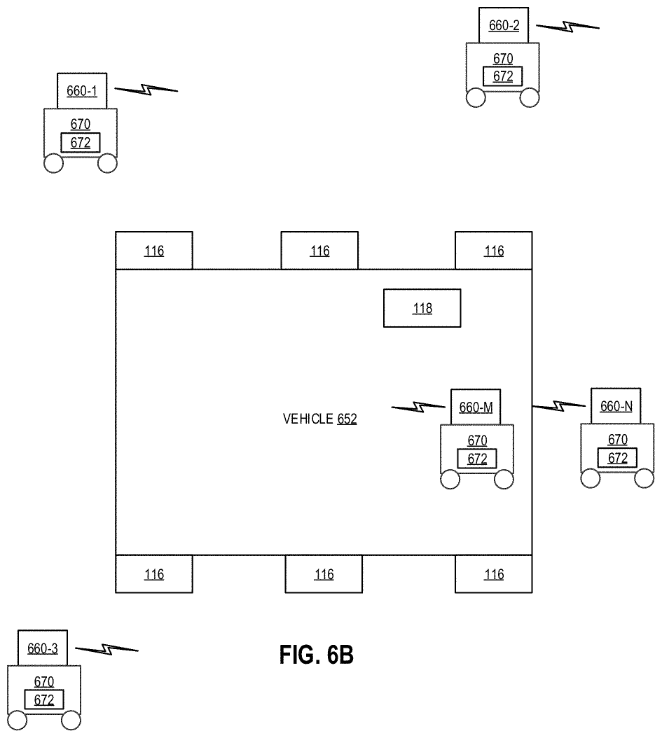

Each of transceivers 216 and 218 receive the beacon message(s) transmitted by wireless access device 250, and measure characteristics associated with the message(s), such as received signal strength or RSSI. The messages and any received data are then forwarded to access device position determination module 228 via central transceiver 214. Access device position determination module 228 may then perform one or more position determination processes. For example, determining which pair of transceivers 216 report the highest received signal strength enables access device position determination module 228 to determine a position of the wireless access device 250 as being located somewhere between those transceivers outside of the vehicle, as discussed in great detail below with respect to FIGS. 7A-7B. As another example, when the interior transceiver 218 reports the strongest received signal, access device position determination module 228 can determine that wireless access device 250 is inside vehicle 202, as discussed in great detail below with respect to FIGS. 7A-7B. In embodiments, access device position determination module 228 can further utilize a trained machine learning model, such as a long short-term memory machine learning model, based analysis to detect, for example, a point position of wireless access device, a relative distance from vehicle, a trajectory of a wireless access device relative to the vehicle, etc. In embodiments, the machine learning model is trained (e.g., during vehicle testing, as part of vehicle manufacture, for vehicle 202, etc.) by generating beacon messages at known positions relative to vehicle, and iteratively feeding reception characteristics into the machine learning model until predictions from the model satisfy an accuracy requirements (e.g., position accuracy+/−X meters, relative distance accuracy+/−Y meters from vehicle, etc.). The training of the machine learning model is discussed in greater detail below with reference to FIGS. 6A-6B.

In embodiments, a combination of the position determination techniques described herein may be used by access device position determination module 228. For example, a position determination technique including the determination of which subset of beacon transceivers receives the strongest signals (e.g., the technique described in FIGS. 7A and 7B) may be used as a cross check to a machine learning model based position determination. As another example, training data may be generated when a machine learning model position determination does not agree, or when it does agree, with another position determination technique. In embodiments, training data may be shared with remote systems (e.g., remote server(s) 180) so that refinement of position determination techniques can be performed over time and as training data/positioning determinations are performed by vehicles of a manufacture, so that the refinements can be re-distrusted to appropriate vehicles of a manufacturer to further improve position determination of wireless access devices.

In embodiments, vehicle access manager 220 then configures one or more vehicle systems (e.g., doors, windows, trunk, hood, charging port door, etc.) based in part on the determined position of wireless access device 250. That is, based on a determined position of wireless access device 250, vehicle access manager may automatically configure vehicle systems (e.g., opening a trunk, unlocking a driver side door, etc.). In another embodiment, the vehicle configuration may be based on the determined position as well as a user command received from the wireless access device (e.g., a button press, a user interface selection, a motion gesture command, or a combination thereof).

In embodiments, the position determination utilizing the trained machine learning model and optional RF fingerprint tuning of the machine learning model enables vehicle access manager 220 to accurately determine wireless access device 250 positions based on received beacon messages. As a result, vehicle configurations that are relevant to wireless access device 250 position relative to vehicle 202 may be more accurately performed.

Furthermore, as discussed herein, the wireless access device 250, the vehicle 202, or a combination, may generate beacon messages for determining a position of wireless access device 250, as discussed herein. Further, these beacon messages can be generated and measured successively over time. Furthermore, when used in combination, the position determination at one time may be verified or cross-checked against the measurements gathered by wireless access device 250 and/or vehicle 202, at the same or different times, to improve the determination of position of the wireless access device 250 relative to vehicle 202 and to guard against erroneous or inaccurate position determinations, should they occur.

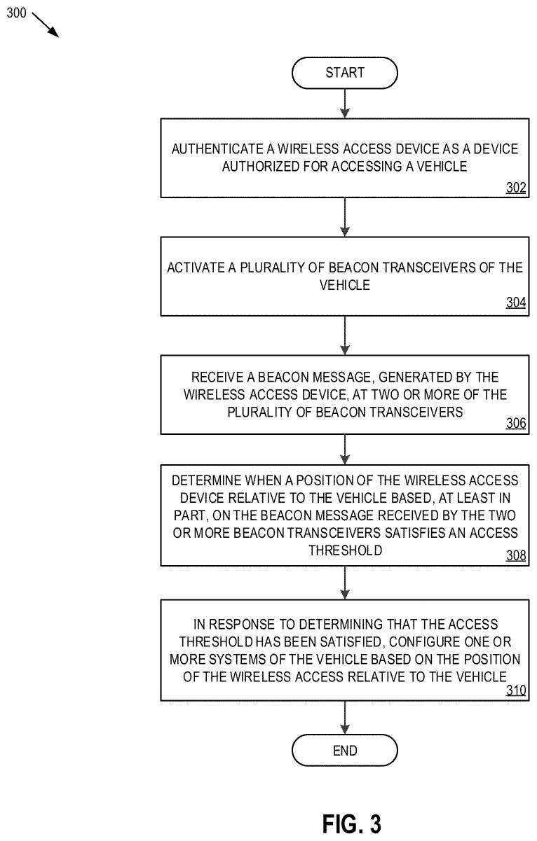

FIG. 3 is a flow diagram of one embodiment of a method 300 for configuring one or more vehicle systems based on authentication and position of a wireless access device using beacon transceivers of a vehicle. The method 300 is performed by processing logic that may comprise hardware (circuitry, dedicated logic, etc.), software (such as is run on a general purpose computer system or a dedicated machine), firmware, or a combination. In one embodiment, the method 300 is performed by a vehicle access manager (e.g., vehicle access manager 120 or 220 of vehicle 102 or 202).

Referring to FIG. 3, processing logic begins by authenticating a wireless access device as a device authorized for accessing a vehicle (processing block 302). In embodiments, the authentication performed by processing logic can include exchanging encryption keys, verifying one or more identifiers received from the wireless access device, negotiating parameters of a wireless connection (e.g., a Bluetooth, Bluetooth low energy, personal area network, wireless local area network, etc. connection), etc. Furthermore, in embodiments, the authentication may be initiated in response to a request received as a wireless message transmitted from the wireless access device, and received at a central transceiver of the vehicle.

Processing logic activates a plurality of beacon transceivers of the vehicle (processing block 304). In embodiments, the beacon transceivers activated by processing logic include a plurality of beacon transceivers distributed about an exterior of the vehicle, but optionally hidden and/or protected by paneling that does not interfere with signal reception and/or transmission. The beacon transceivers activated by processing logic also include at least one interior beacon transceiver located within the interior of the vehicle, such as within a passenger cabin of the vehicle.

Processing logic receives a beacon message, generated by the wireless access device, at two or more of the plurality of beacon transceivers (processing block 306). As discussed herein, in embodiments, the beacon transceivers may be configured by processing logic to transmit beacon messages for reception by wireless access device. Additionally, in some embodiments, both wireless access device and beacon transceivers may be both beacon message transmitters and receivers, as discussed herein.

Processing logic then determines when a position of the wireless access device relative to the vehicle based (e.g., distance or closeness to a specific portion of the vehicle) satisfies an access threshold (processing block 308). In embodiments, the beacon message can include one or more identifiers associated with the wireless access device, one or more identifiers associated with the message, one or more identifiers associated with the car, as well as a combination of identifiers. The beacon message may also include additional data, such as signal transmission strength. Processing logic may then utilize the data within the beacon message, along with additional data collected/measured by the beacon transceivers (e.g., measured signal strength associated with the received beacon message), to perform one or more position determination process(es). In embodiments, the position determination process can include, as discussed herein, determining which pair of beacon transceivers measure the highest signal strength for determining which pair of transceivers the wireless access device is closest to, determining when an interior transceiver measures a highest signal strength for determining that the wireless access device is within the vehicle, using a pattern of measured signal strengths from each of the beacon transceivers to determine a distance from the vehicle and/or real world position of wireless access device relative to the vehicle, using trilateration based on received signal strengths, etc. Furthermore, as discussed herein, a RF environment fingerprint and/or a machine learning model may be utilized by processing logic for determining wireless access device position, as discussed herein. In embodiments, a combination of techniques and/or RF environment tuning may be used by processing logic to improve the accuracy with which wireless access device position relative to the vehicle is determined. Furthermore, in embodiments, the access device threshold can include a plurality of different thresholds, each being associated with certain position based functions for providing access to, and configuration of, vehicle. For example, based on a relative position of wireless access device with respect to the vehicle (e.g., rear, front, left front door, left back door, right front door, right rear door, charging port, etc.), and the distance away from the vehicle satisfying a distance based threshold (e.g., within 1 meter, within 3 meters, within 5 meters, etc.), a position based function may be executed by processing logic (e.g., unlocking a driver side door, opening a trunk, popping a charging port door, starting a vehicle ignition, authorizing driving, etc.). Furthermore, when such position is tracked over time (e.g. repeating processing blocks 306 and 308 at different times), processing logic may select and/or activate the function based on predicted/updated position data including, for example, determining that a user is currently outside of a threshold but is approaching the threshold associated with a right rear door, rear end, front left door, etc.

Therefore, in response to determining that the access threshold has been satisfied, processing logic configures one or more systems of the vehicle based on the position of the wireless access device relative to the vehicle (processing block 310). In embodiments, additional information, such as an identifier of a user of the wireless access device may also assist processing logic in execution of the position based functions or vehicle configurations. For example, a first user having a first wireless access device may be associated with driving privileges for the vehicle, while a second user is associated with access but not operational privileges for the vehicle. Any combination of position based, distance based, user based, etc. factors may be used by processing logic when configuring the vehicle for the wireless access device based on its determined position relative to the vehicle.

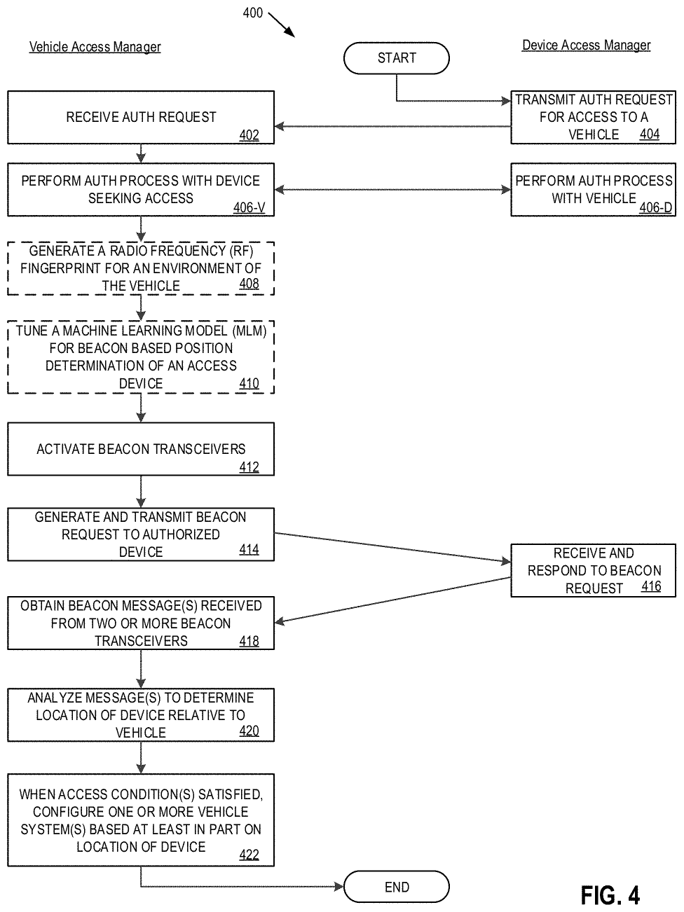

FIG. 4 is a flow diagram of another embodiment of a method 400 for configuring one or more vehicle systems based on authentication and position of a wireless access device using beacon transceivers of a vehicle. The method 400 is performed by processing logic that may comprise hardware (circuitry, dedicated logic, etc.), software (such as is run on a general purpose computer system or a dedicated machine), firmware, or a combination. In one embodiment, the method 400 is performed by a vehicle access manager (e.g., vehicle access manager 120 or 220 of vehicle 102 or 202) and a device access manager (e.g., device access manager 170 or 270 of wireless access device 160 or 250).

Referring to FIG. 4, processing logic begins by transmitting, by the device access manager, an authentication request to a vehicle (processing block 404). The transmission of the authentication request may be made in response to a user command received by the device access manager, such as the pressing of a button on a key fob, receiving a motion based gesture command generated by the key fob, receiving a user selection of an interface element in an app run by a smart phone, the turning on of an access card, etc. In embodiments discussed herein, the authentication request can include one or more identifiers, encryption keys, etc. used for authenticating a wireless access device to the vehicle, and vice versa.

Processing logic of the vehicle access manager receives the authentication request (processing block 402), and performs an authentication process with the device seeking access (processing block 406-V). The processing logic of the device access manager performs a complimentary authentication process with the vehicle (processing block 406-D). During the authentication process, identifiers are verified, encryption keys verified, encryption keys exchanged, wireless connection parameters exchanged, etc.

Processing logic of the vehicle access manager then optionally generates a radio frequency (RF) fingerprint for an environment of the vehicle (processing block 408). As discussed in greater detail below, the generation of an RF fingerprint includes selectively activating subsets of the vehicle beacon transceivers, such as subsets corresponding to one or more tuples of beacons configured to act as transmitters and others configured to act as receivers, so that each of the beacon transceivers receives messages transmitted from the remaining transceivers. The pattern of reception at each of the beacon transceivers forms an RF fingerprint of the RF environment in which the vehicle is currently located, and which processing logic compares with pre-generated RF fingerprinted generated under controlled conditions in different RF environments. Based on the comparison, the best matching RF fingerprint is selected as representative of the current RF environment. The generation of RF fingerprints is discussed in greater detail below with respect to FIGS. 5A-5C.

Processing logic further optionally tunes a machine learning model (MLM) for beacon based position determination of an access device (processing block 410). In embodiments, a MLM, such as a neural network, recurrent neural network, long short-term memory network, etc. can be trained by feeding the MLM training data as discussed in greater detail below. The training data includes patterns of reception by vehicle beacon transceivers for transmission generated at a plurality of specific/known positions and/or in different RF environments. Once trained, the MLM can use the pattern of reception, for example including measured signal strengths for beacon messages, as an input to the MLM, with the output being the wireless access devices position. Thus, the tuning can include selecting between different MLMs based on determined RF fingerprint, adjusting weighting of transition functions of an MLM, providing the RF fingerprint as an additional input to the MLM, or a combination thereof. The training of the MLM is discussed in greater detail below with respect to FIGS. 6A-6B.

Processing logic of the vehicle access manager activates a plurality of beacon transceivers of the vehicle (processing block 412). In embodiments, this can include powering the transceivers, waking the transceivers, transitioning the transceivers to an active states, etc. Processing logic then generates and transmits a request to the authorized device to begin transmission of beacon messages (block 414). The processing logic of the device access manager receives the request and accordingly responds by transmitting one or more beacon messages (processing block 416). In embodiments, the beacon transceivers may alternatively and/or additionally be configured to transmit beacon messages to the wireless access device.

Processing logic of the vehicle access manager obtains the beacon messages received form two or more of the beacon transceivers (processing block 418), and analyzes the beacon messages (e.g., a pattern of signal strengths, relative signal strengths, etc.) using, for example, trilateration, a technique using relative signal strengths received by subsets of beacon transceivers, a MLM model, or a combination of position determination techniques to determine a position of a wireless access device relative to the vehicle (processing block 420). In embodiments, the MLM may be tuned according to a determined RF environment to enhance the position determination performed by processing logic.

In optional embodiment(s), as discussed herein, the beacon transceivers may be configured by processing logic to also transmit beacon messages, for reception by the wireless access device. Wireless access device may then use the messages to either perform its own position determination (e.g., similar to processing block 418 and 420) and/or transmit the received beacon messages/signal measurements to processing logic of the vehicle access manager. In this optional embodiment, the multiple position determinations serve as a coherency check to guard against erroneous and/or in accurate positioning determinations. Furthermore, in some embodiments, both wireless access device and beacon transceivers may be configured as both beacon message transmitters and receivers, as discussed herein.

Processing logic of the vehicle access manger then configures one or more vehicle system(s) based at least in part on the position of the wireless access device when access condition(s) are satisfied (processing block 422). As discussed herein, different access conditions can be associated with a combination of various factors, such as identification of a user of a wireless access device, identification of the wireless access device, determined position of wireless access device relative to the vehicle, distance of wireless access device from the vehicle, position of wireless access device within vehicle, etc. Configurations, as discussed herein, can include activating or authorizing use of various vehicle systems, such as doors, windows, starting up, etc. based on the determined position of the wireless access device.

In embodiments, the position of the wireless access device may therefore be accurately determined using the beacon based message techniques discussed herein. Furthermore, access to and configuration of the vehicle may be position based, with customization for different access devices, users, etc. To further enhance positioning determination, RF fingerprinting and machine learning model training may be utilized, as discussed in greater detail below.

FIG. 5A is a flow diagram of one embodiment of a method 500 for generating radio frequency fingerprints of an environment of a vehicle. The method 500 is performed by processing logic that may comprise hardware (circuitry, dedicated logic, etc.), software (such as is run on a general purpose computer system or a dedicated machine), firmware, or a combination. In one embodiment, the method 500 is performed by a vehicle access manager (e.g., vehicle access manager 120 or 220 of vehicle 102 or 202). In embodiments, the method may alternatively be performed during vehicle manufacture and/or testing, by a computer processing system communicatively coupled with a vehicle.

Referring to FIG. 5A, processing logic begins by initiating an RF fingerprint generation process for an environment of a vehicle (processing block 502). The RF environment includes objects or architectural elements (e.g., indoor or outdoor, ceilings or walls, etc.) that may or may not surround the vehicle, as well as other objects or elements located within the environment of the vehicle. Therefore, the method 500 may be repeated for a plurality of different RF environments for pre-generating a plurality of different RF fingerprints. For example, and as illustrated in FIG. 5E, an RF environment 560-1 may include a vehicle 562 alone, another RF environment 560-2 may include a vehicle 564 on one side of vehicle 562, while multiple vehicles 564 may be next to vehicle 562 in another RF environment 560-3. Vehicles are not the only objects or elements in RF environments, which can include RF environments 560-i and 560-k that include a wall 566 and/or a garage/enclosure 568. The main materials with which the objects or elements are made of may also vary RF environments, for example, woods, metals, or plastics, or their combinations. Any number of RF environments with any number of objects or elements made of various materials may be used when generating RF fingerprints.

Processing logic, for the RF environment for which an RF fingerprint is being generated, transmits radio signals from each of a plurality of subsets of beacon transceivers of the vehicle (processing block 504), which is received by a beacon transceiver not within the transmitting subset (processing block 504). Processing blocks 504 and 506 repeat until each transceiver of vehicle has received radio signals during RF fingerprint generation. Furthermore, in embodiments, each transceiver is configured to transmit at a predetermined power level.

In embodiments, different subsets of beacon transceivers may be selectively activated when generating RF fingerprints for different environments. For example, as illustrated in FIG. 5B, a rotation of beacon transceivers in vehicle 552 is used such that a first beacon transceiver 116 receives radio signals transmitted from the remaining beacon transceivers 116 and 118 (e.g., 550-1), a second beacon transceiver 116 receives radio signals transmitted from the remaining beacon transceivers 116 and 118 (e.g., 550-2), and so on until a final beacon transceiver 118 receives radio signals transmitted from the remaining beacon transceivers 116 (e.g., 550-N). Furthermore, the rotation ensures that each beacon transceiver acts as a receiver for reception of radio signal, which can be repeated in various RF environments, such as but not limited to, those illustrated in FIG. 5E.

In embodiments, any number of tuples of beacon transceiver(s(can be configured as transmitter(s), and remaining beacon transceiver(s) configured as receiver(s). For example, successive subsets of six transceivers may transmit signals to single receivers, successive subsets of five transceivers may transmit signals to sets of two receivers, successive subsets of four transceivers may transmit signals to sets of three receivers, and so on until, as illustrated FIG. 5C, success single transceivers transmit to sets of six receivers. Furthermore, the central transceiver in a vehicle may also be used such that the tuples include sets of 7 transmitting transceivers and 1 receiving transceiver to sets of 1 transmitting transceiver and 7 receiving transceivers, as illustrated by the example in FIG. 5D. In embodiments, each of these tuples may be used, or a combination of tuples used, with or without the central transceiver when generating an RF fingerprint for an environment.

In an embodiment, processing logic may begin the transmission of radio signals from each of a plurality of subsets of beacon transceivers (e.g., one of the tuples) of the vehicle by first having a central transceiver or subset of transceivers initially transmit a signal at a constant power for a predetermined amount of time, for example 5 seconds, 10 second, 30 seconds, etc. Every other beacon transceiver not in the transmitting subset may then measure the RSSI (relative received signal strength) of the transmission. Each beacon transceiver or successive subsets of beacon transceivers is then selectively activated to similarly transmit a signal at the constant power for a predetermined amount of time, such as 5 second, 10 second, 30 seconds, etc., which the remaining beacon transceivers and optionally the central transceiver use to measure RSSIs. From the measured RSSIs over the predetermined amount of time for each subset of each tuples used for generating the RF fingerprint, processing logic can, in embodiments, select a subset of the RSSI measurement for a consistent period of measurement (e.g., a constant or relatively constant RSSI measured over a 50, 100, 150, etc. millisecond interval), where the consistent measurement is associated with an accurate measurement (e.g., not subject to spiking, interference other than that of the RF environment, etc.). That is, the RSSIs, as discussed herein, may be influenced by the RF environment in which the RF fingerprint is being generated, as well as the object contained therein, for example due to signal attenuation, signal blocking, signal reflections, etc., and thus the period of relatively constant RSSI is chose as providing an accurate RSSI measurement.

Processing logic then generates an RF fingerprint of the environment of the vehicle based on a pattern of reception of the radio signals generated by each of the plurality of subsets of beacon transceiver (processing block 508). In embodiments, the environment impacts the pattern of reception, such as by signal attenuation, signal reflection, blocking, etc. caused by the objects or elements in the environment. In embodiments, the RF fingerprint may be a reference pattern based on the received signals, may include the received signals, may characterize relative signal strengths, may include the position of the transmitting and receiving transceivers relative to the vehicle, as well as other forms that enable distinguishing of different RF environments based on received signals data. For example, in embodiments, the reference pattern for an RF fingerprint for an RF environment may be generated from the selected RSSI measurements from each iteration of transceiver signal generation/reception for select tuples, and used as a reference pattern for matching a current RF environment in which the vehicle is located using corresponding tuples, as discussed herein.

In embodiments, as discussed herein, a vehicle, such as vehicle 102 or 202, may also perform the process described and illustrated with respect to FIG. 5A. The vehicle performs the process before wireless access device position determination, as discussed above in FIGS. 3 and 4, to match and select a closest RF fingerprint based on pre-generated RF fingerprint reference patterns. In embodiments, the vehicle may further detect and collect any discrepancy between the expected behavior (e.g., RF fingerprint and positioning predicts user position at front driver side door) and the actual detected user behavior (e.g., user selects to open front passenger side door). In embodiments, the actual detected user behavior may be used with the actual RF fingerprint measurements when a discrepancy is encountered to feed back RF fingerprint measurements that led to the discrepancy, into the RF fingerprint training process discussed in FIG. 5A above, to further refine a RF fingerprint reference patter based on actual usage data.

In embodiments, the RF fingerprinting may further be used during MLM training to distinguish MLM based position of a wireless access device in different RF environments.

FIG. 6A is a flow diagram of one embodiment of a method 600 for training a machine learning model for use in positioning determination for a wireless access device seeking to access and configure a vehicle. The method 600 is performed by processing logic that may comprise hardware (circuitry, dedicated logic, etc.), software (such as is run on a general purpose computer system or a dedicated machine), firmware, or a combination. In one embodiment, the method 600 is performed by a vehicle access manager (e.g., vehicle access manager 120 or 220 of vehicle 102 or 202). In embodiments, the method may be performed during vehicle manufacture and/or testing. In other embodiments, additional machine learning model training may be performed when a user provides feedback, such as a failed position result, in response to a detected and/or user confirmed discrepancy between a predicated position and actual user action (as discussed above in FIG. 5A), etc.

Referring to FIG. 6A, processing logic begins by obtaining beacon messages received from two or more beacon transceivers of a vehicle for a known position of an access device (processing block 602). In embodiments, the known position is a position (e.g., absolute or relative to vehicle) from which a wireless access device is transmitting beacon messages. Furthermore, the obtaining of beacon messages is repeated a plurality of times at a plurality of known positions for generating a collection of MLM training data. For example, as illustrated in FIG. 6B, a wireless access device generates and transmits beacon messages from positions 660-1, 660-2, 660-3, 660-N, and 660-M, which are outside and inside the vehicle. These positions are illustrative, as different and/or additional positions may be utilized for generation of the collection of MLM training data. Furthermore, the known positions may be communicated to processing logic in the beacon messages or by a secondary system 670, where the known positions are determined from a positioning system 672 of the secondary system 670 that is capable of accurately determining an absolute and/or relative position of wireless access device 660 to vehicle 652. For example, secondary system 670 may be a robot or other automated system capable of reliably and accurately moving and providing a position of the wireless access device 660 relative to vehicle 652 over a large number of positions, the known positions determined from the high precision positioning process performed by positioning system 672 (such as assisted GPS based positioning, mechanical position measurements, etc), provide transmit position of a wireless access device as MLM training data to build a corpus of MLM training data.

Processing logic provides the radio frequency signal data, such as received signal strength measurements (e.g., RSSI measurements), from the obtained beacon messages and associated position data of the wireless access device, such as x, y, z positions tracked by a secondary relative to the vehicle, generated from a high precision positioning process, or other automated technique, to a machine learning model trainer (processing block 604). In embodiments, the trainer is a MLM trainer that iteratively feeds data from the generated collection of MLM training data to refine the MLM model for detection of access device position based on received radio frequency signal data (processing block 606). For example, a long short-term memory machine learning model may be trained by radio signal inputs and know positions to iteratively adjust and train the long short-term memory machine learning model to accurately generate an output associated with the known positions. In embodiments, the training data (e.g. RSSI measurements and associated wireless access device positions) may be stored in a database, and accessed by the MLM trainer during a training process. Additionally, real world training data, such as that updated to remote server(s) (e.g. server(s) 180) by vehicles, such as position determinations cross-checked with MLM based position determinations, may also be fed into the MLM during training and/or refinement. That is, other MLMs and training methods may be used to train the MLM using the generated collection of radio signal transmission data and associated known positions. For example, radio signal inputs and user approved discrepancy reports (e.g., predicted position of user relative to a vehicle differs from user command received at a different position relative to the vehicle) may also be used to train/refine a MLM consistent with the discussion herein.

Furthermore, the process illustrated in FIG. 6A may be repeated for a number of RF environments (e.g., indoor parking space or outdoor parking space), as illustrated in FIG. 5E. In embodiments, different MLMs may be generated/trained for the different environments. In other embodiments, the identification of the RF environment (e.g., by RF fingerprint) may be an additional input to the trained MLM. In yet other embodiments, the identification of the RF environment (e.g., by RF fingerprint) may be used to adjust one or more MLM parameters. In any of the embodiments, the MLM(s) may be trained to accurately determine wireless access device position based on received radio signal data, such as that in beacon messages. Furthermore, the MLM(s) may be trained to perform the position determination in any number of different RF environments.

FIG. 7A is a flow diagram of one embodiment of a method 700 for determining a position of a wireless access device using a subset of beacon transceivers of a vehicle and relative signal strengths of radio signals received by the subset. The method 700 is performed by processing logic that may comprise hardware (circuitry, dedicated logic, etc.), software (such as is run on a general purpose computer system or a dedicated machine), firmware, or a combination. In one embodiment, the method 700 is performed by a vehicle access manager (e.g., vehicle access manager 120 or 220 of vehicle 102 or 202). In embodiments, the method may be performed to determine a position of a wireless access device relative to a vehicle. Furthermore, in embodiments, the method may be performed as a cross-check against another position determination technique, such as a machine learning model based position determination technique.

Referring to FIG. 7A, processing logic begins by obtaining a beacon message, received from a subset of beacon transceivers of a vehicle, from a wireless access device seeking to access a vehicle 702 (processing block 702). In embodiments, the beacon message is transmitted by the wireless access device as discussed in greater detail above. In embodiments, the subset of beacon transceivers receiving the beacon message can include all beacon transceivers of a vehicle, or only a portion (e.g., one, two, or more) beacon transceivers. As discussed below, the relative signal strengths received by particular beacon transceivers enable processing logic to determine a position of the wireless access device relative to the vehicle.

For each beacon transceiver receiving the beacon message, processing logic determines a strength of the beacon message received from the wireless access device (processing block 704). Processing logic then determines a position of the wireless access device relative to the vehicle based, at least in part, on relative beacon message strength(s) of the beacon message(s) received by one or more beacon transceivers of the vehicle (processing block 706). In embodiments, the relative signal strengths may be RSSI measurements, received signal power, etc.

FIG. 7B is a block diagram illustrating a vehicle and a plurality of regions of the vehicle in which a wireless access device can be detected using relative signal strengths of signals generated by the wireless access device and received by subsets of beacon transceivers. As illustrated in FIG. 7B, vehicle 752 includes a plurality of regions, including but not limited to, inside, outside, front, rear, left front door, left back door, right front door, and right back door. Processing logic of FIG. 7A at processing block 706 utilizes the strongest two signals from any of transceivers 716-1 through 716-6 to determine a position of the wireless access device as being in a region relative to vehicle 752. For example, when transceiver 716-1 and 716-2 measure the strongest received signals relative to the remaining transceiver, processing logic is able to determine that a wireless access device's position is within signal transmission/reception range and is positioned in the front region relative to vehicle 752. If the strongest signal is from transceiver 716-4 and the second strongest signal is from the transceiver 716-3, or similarly if the strongest signal is from transceiver 716-3 and the second strongest signal is from the transceiver 716-4, processing logic can determine the position of wireless access device as being in the relative position associated with the rear back door. In one embodiment, if the strongest signal is from transceiver 716-3, the second strongest signal is from the transceiver 716-4 and a third strongest signal is from transceiver 716-7, then again processing logic can determine the wireless access device's position in the area relative to vehicle associated with the rear back door. In embodiments, processing logic utilizes the two strongest signals received by any of beacon transceivers 716 as an indication of the relative position of wireless access device to vehicle 752. In one embodiment, where the strongest signal is received by internal transceiver 718, however, the second signal's relative value is not needed by processing logic as internal transceiver 718 will have the strongest received signal when the wireless access device is within the vehicle.

Returning to FIG. 7A, after determining a position of the wireless access device, processing logic returns to processing block 702 to repeat blocks 702-706. As a result, processing logic determines a position of the wireless access device, and the associated signal strengths received by the transceivers, over a period of time. In one embodiment, the success position determinations may be used in some scenarios to determine position, as well as to determine when a user of the wireless access device is approaching a vehicle, moving away from a vehicle, transitioning between positions relative to the vehicle, etc. For example, if the wireless access device is exactly in the middle of two transceivers, for example transceiver 716-2 and transceiver 716-4, then the strongest signal would be detected by transceiver 716-3. However, the second strongest signal could be from transceiver 716-2 and/or transceiver 716-4. In this example, processing logic utilizes he previously determined wireless access device position. That is, if the user of the wireless access device is moving (e.g., as determined from successive position determination(s)) from the right front door region of the vehicle to the right rear door region of the vehicle, processing logic is able to determine that the current wireless access device position is in the right rear door area instead of the right front door area based on the trajectory or movement of the wireless access device relative to the vehicle. That is, when two beacon transceivers measure the same, or substantially similar (e.g., within a predetermined value, percentage, error, etc. of one another), movement data associated with the wireless access device (e.g., position determinations over time) is used by processing logic to select between the same/substantially similar measurements.

In embodiments, the position determination between regions relative to a vehicle may be performed using any of the beacon transceivers, and not just those discussed in the examples above. Furthermore, the position determination technique discussed with respect to FIGS. 7A and 7B may be used in conjunction with other techniques (e.g., with a machine learning technique) as cross-checks against one another. Furthermore, the technique discussed with respect to FIGS. 7A and 7B may be relatively more computationally efficient, and may provide an initial position determination of a wireless access device that is confirmed and/or refined by another technique, such as a machine learning technique.

Those of skill would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the methods, systems, and apparatus of the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for providing access to a vehicle using a wireless access device, the method comprising:
activating a plurality of beacon transceivers of the vehicle;
determining, based at least in part on at least one beacon message received by the beacon transceivers, the wireless access device, or a combination thereof, when a position of the wireless access device relative to the vehicle satisfies an access threshold; and
in response to determining that the access threshold has been satisfied, configuring one or more systems of the vehicle based on the position of the wireless access device relative to the vehicle.

2. The method of claim 1, further comprising:
transmitting a wireless message to the wireless access device to request that the wireless access device generate a beacon message;
receiving, by at least two of the plurality of beacon transceivers, the beacon message generated by the wireless access device; and
determining, based at least in part on the beacon message received by the at least two of the plurality of beacon transceivers, when the position of the wireless access device relative to the vehicle satisfies the access threshold.

3. The method of claim 2, wherein a first position of the wireless access device relative to the vehicle is determined during a first time period and a second position of the wireless access device relative to the vehicle is determined during a second time period, and wherein a difference of the first position and the second position relative to the vehicle between the first time period and the second time period is indicative of a movement of the wireless access device relative to the vehicle.

4. The method of claim 3, further comprising:
determining to configure the one or more systems of the vehicle based on the position of the wireless access device relative to the vehicle and based on determined movement of the wireless access device indicative of movement towards the vehicle; and
determining not to configure the one or more systems of the vehicle based on the position of the wireless access device relative to the vehicle and based on determined movement of the wireless access device indicative of movement away the vehicle.

5. The method of claim 2, wherein determining the position of the wireless access device relative to the vehicle comprises:
measuring radio signal strengths of the received beacon message at each of the plurality of beacon transceivers;
determining the relative radio signal strengths of the received beacon message at each of the plurality of beacon transceivers; and
determining the position of the wireless access device relative to the vehicle using a machine learning model analysis of the determined relative radio signal strengths and the position of each of the plurality of beacon transceivers on the vehicle.

6. The method of claim 5, further comprising:
obtaining a beacon message, received from one or more beacon transceivers of the vehicle, wherein the beacon message is transmitted from the wireless access device;
determining, for each beacon transceiver receiving the beacon message, a strength of the signal containing the beacon message;
determining a second position of the wireless access device relative to the vehicle using relative beacon message signal strengths of the beacon messages received by the one or more beacon transceivers of the vehicle;
comparing the position with the second position; and
determining a new position of the wireless access device relative to the vehicle when the position does not match the second position.

7. The method of claim 5, further comprising:
generating a radio frequency fingerprint indicative of the environment in which the vehicle is located;
determining a radio frequency environment based on a comparison of the generated radio frequency fingerprint and a plurality of pregenerated radio frequency fingerprints, each of the pregenerated radio frequency fingerprints being associated with a different radio frequency environment; and
utilizing the determined radio frequency environment to tune a machine learning model that analyzes the measured radio signal strengths to determine the position of the wireless access device.

8. The method of claim 7, wherein generating the radio frequency fingerprint indicative of the environment in which the vehicle is located further comprises:
transmitting a radio signal from a subset of beacon transceivers of the vehicle;
receiving the radio signal at one or more beacon transceivers of the vehicle not within the transmitting subset;
repeating the transmitting and receiving for each of a plurality of different subsets of beacon transceivers; and
generating the radio frequency fingerprint of the radio frequency environment of the vehicle based on a pattern of reception of the radio signals.

9. The method of claim 5, wherein the machine learning model is a trained long short-term memory network.

10. The method of claim 5, further comprising:
transmitting, from the vehicle to a remote server as training data, the determined position of the wireless access device relative to the vehicle with signal parameters associated with at least one beacon message received by the beacon transceivers, wherein the remote server uses the training data received from the vehicle and training data received from other vehicles to refine the machine learning model; and
receiving an updated machine learning model from the remote server; and
using the updated machine learning model to determine a new position of the wireless access device.

11. The method of claim 2, further comprising:
obtaining a beacon message, received from one or more beacon transceivers of the vehicle, wherein the beacon message is transmitted from the wireless access device;
determining, for each beacon transceiver receiving the beacon message, a strength of the signal containing the beacon message; and
determining the position of the wireless access device relative to the vehicle using relative beacon message signal strengths of the beacon messages received by the one or more beacon transceivers of the vehicle.

12. The method of claim 11, wherein using relative beacon message signal strengths to determine the position of the wireless access device further comprises:
determining a first position of the wireless access device as being between two beacon transceivers relative to an exterior of the vehicle when the two beacon transceivers are associated with a strongest and next strongest signal strength of signals containing the beacon message; and
determining the first position of the wireless access device as being inside the vehicle when the an interior beacon transceivers within the vehicle is associated with a strongest signal strength of signals containing the beacon message.

13. The method of claim 2, wherein the beacon message generated by the wireless access device comprises a wireless beacon message transmitted using a personal area network protocol for the exchanger of wireless messages.

14. The method of claim 1, wherein prior to activating the plurality of beacon transceivers, the method further comprises:
receiving a wireless message transmitted from the wireless access device for initiating authentication of the wireless access device to the vehicle;
authenticating the wireless access device as a device authorized for accessing the vehicle, wherein authentication of the wireless device is based on an identifier of the wireless access device, an identifier of a user associated with the wireless access device, a cryptographic key received from the wireless access device, or a combination thereof; and
in response to authenticating the wireless access device, activating the plurality of beacon transceivers.

15. The method of claim 14, wherein the wireless access device comprises a key fob, and wherein the key fob transmits the wireless message in response to a user pressing a button of the key fob.

16. The method of claim 14, wherein the wireless access device comprises one of a mobile telephone, a wearable device, or a tablet computer executing an application associated with a manufacturer of the vehicle, and wherein the application transmits the wireless message in response to receipt of input from a user received via an interface of the wireless access device.

17. The method of claim 14, wherein the wireless access device comprises a wireless access card comprising a transceiver, and wherein the wireless access card transmits the wireless message in response to being powered on by a user.

18. The method of claim 1, wherein the plurality of beacon transceivers comprise at least two exterior beacon transceivers each being disposed outside of a frame of the vehicle, and wherein the plurality of beacon transceivers comprise at least one interior beacon transceiver disposed in an interior cabin of the vehicle.

19. The method of claim 18, wherein the at least two exterior beacon transceivers comprise six beacon transceivers distributed around a perimeter of the vehicle.

20. The method of claim 1, wherein the vehicle is a partially or fully electric car.

21. The method of claim 1, further comprising:
forwarding, by the at least two of the plurality of beacon transceivers to a central transceiver via wireless messaging, the received the beacon message; and
providing, by the central transceiver to a processing system of the vehicle, the received beacon message; and
performing the determining and the configuring by the processing system of the vehicle.

22. The method of claim 1, wherein the beacon message comprises one or more of a device identifier, a user identifier, a beacon message identifier, data indicative of a signal transmission strength, or a combination thereof.

23. A system for providing access to a vehicle using a wireless access device, the system comprising:
a plurality of beacon transceivers of the vehicle;
a central transceiver communicably coupled with the plurality of beacon transceivers; and
a processor communicably coupled with the central transceiver, the processor configured to:
activate the plurality of beacon transceivers of the vehicle,
determine, based at least in part on at least one beacon message received by the beacon transceivers, the wireless access device, or a combination thereof, when a position of the wireless access device relative to the vehicle satisfies an access threshold, and
in response to determination that the access threshold has been satisfied, configure one or more systems of the vehicle based on the position of the wireless access device relative to the vehicle.

24. The system of claim 23, further comprising:
transmit, via the central transceiver, a wireless message to the wireless access device to request that the wireless access device generate a beacon message;
receive, by at least two of the plurality of beacon transceivers, the beacon message generated by the wireless access device; and
determine, by the processor based at least in part on the beacon message received by the at least two of the plurality of beacon transceivers, when the position of the wireless access device relative to the vehicle satisfies the access threshold.

25. The system of claim 24, wherein the processor to determine the position of the wireless access device relative to the vehicle comprises the processor configured to:
measure radio signal strengths of the received beacon message at each of the plurality of beacon transceivers;
determine the relative radio signal strengths of the received beacon message at each of the plurality of beacon transceivers; and
determine a position of the wireless access device relative to the vehicle using a machine learning model analysis of the determined relative radio signal strengths and the position of each of the plurality of beacon transceivers on the vehicle.

26. The system of claim 24, wherein the processor to determine the position of the wireless access device relative to the vehicle comprises the processor configured to:
obtain a beacon message, received from one or more of the beacon transceivers of the vehicle, wherein the beacon message is transmitted from the wireless access device;
determine, for each beacon transceiver receiving the beacon message, a strength of the signal containing the beacon message; and
determine the position of the wireless access device relative to the vehicle using relative beacon message signal strengths of the beacon messages received by the one or more beacon transceivers of the vehicle.

27. The system of claim 23, wherein the vehicle is a partially or fully electric car.

28. A non-transitory computer readable storage medium including instructions that, when executed by one or more processors, causes the one or more processors to perform operations providing access to a vehicle using a wireless access device, the operations comprising:
activating a plurality of beacon transceivers of the vehicle;
determining, based at least in part on at least one beacon message received by the beacon transceivers, the wireless access device, or a combination thereof, when a position of the wireless access device relative to the vehicle satisfies an access threshold; and
in response to determining that the access threshold has been satisfied, configuring one or more systems of the vehicle based on the position of the wireless access device relative to the vehicle.

29. The non-transitory computer readable storage medium of claim 28, further comprising:
transmitting a wireless message to the wireless access device to request that the wireless access device generate a beacon message;
receiving, by at least two of the plurality of beacon transceivers, the beacon message generated by the wireless access device; and
determining, based at least in part on the beacon message received by the at least two of the plurality of beacon transceivers, when the position of the wireless access device relative to the vehicle satisfies the access threshold.

30. The non-transitory computer readable storage medium of claim 28, wherein the vehicle is a partially or fully electric car.
